(19) United States
(12) Patent Application Publication
(10) Pub. No.: US 2017/0111904 A1
(43) Pub. Date: Apr. 20, 2017

(54) DETERMINISTIC TRANSMISSION OF COMMUNICATION PACKETS OF MULTIPLE PROTOCOLS ON A NETWORK

(71) Applicant: Schweitzer Engineering Laboratories, Inc., Pullman, WA (US)

(72) Inventor: Ryan Bradetich, Pullman, WA (US)

(21) Appl. No.: 15/293,647

(22) Filed: Oct. 14, 2016

Related U.S. Application Data
(60) Provisional application No. 62/241,139, filed on Oct. 14, 2015.

(51) Int. Cl. H04W 72/04; H04W 76/02; H04L 12/46

(52) U.S. Cl. CPC H04W 72/0446; H04L 12/4633; H04W 76/026

(57) ABSTRACT

Systems and methods for preserving determinism of communications formatted according to a deterministic communication protocol where communications formatted according to various communications protocols are transmitted. The system includes a packet parsing module and a multiplexing engine to determine scheduled egress times and delay transmission of certain communications until communications that are formatted according to the deterministic communication protocol have egressed an outbound port.

### RELATED APPLICATIONS FIELD

This application claims priority under 35 U.S.C. §119(e) to U.S. Provisional Patent Application No. 62/241,139, filed Oct. 14, 2015, and entitled “Deterministic Transmission of Communication Packets of Multiple Protocols on a Single Network,” which is incorporated herein by reference in its entirety.

### TECHNICAL FIELD

This disclosure relates to systems and methods for managing communication between devices in an electric power generation and delivery system and, more particularly, to systems and methods for managing the deterministic transmission of communication packets of multiple communication protocols over network communication channels.

### BRIEF DESCRIPTION OF THE DRAWINGS

Non-limiting and non-exhaustive embodiments of the disclosure are described, including various embodiments of the disclosure, with reference to the figures, in which:

FIG. 1 illustrates a simplified one-line diagram of an electric power delivery system and associated intelligent electronic devices consistent with certain embodiments disclosed herein.

FIG. 2 illustrates a simplified block diagram of a communications system for communicating using multiple protocols on a communications network consistent with certain embodiments disclosed herein.

FIG. 3 illustrates a functional block diagram of a communication device for communicating Ethernet and other communication packets on a network consistent with certain embodiments disclosed herein.

FIG. 4 illustrates a functional block diagram of a device that may be used to improve the transmission of data over a communication channel consistent with certain embodiments disclosed herein.

FIG. 5 illustrates a functional block diagram of a communication device consistent with certain embodiments disclosed herein.

FIG. 6 illustrates a conceptual diagram of inbound communications traffic of a communication device consistent with certain embodiments disclosed herein.

FIG. 7 illustrates a conceptual diagram of outbound communication traffic of a communication device consistent with certain embodiments disclosed herein.

FIG. 8 illustrates another conceptual diagram of outbound communication traffic of a communication device consistent with certain embodiments disclosed herein.

FIG. 9 illustrates a flow chart of a method for managing communication traffic consistent with certain embodiments disclosed herein.

### DETAILED DESCRIPTION

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Electrical power generation and delivery systems are designed to generate, transmit, and distribute electrical energy to loads. Electrical power generation and delivery systems may include a variety of equipment such as electrical generators, electrical motors, power transformers, power transmission and distribution lines, circuit breakers, switches, buses, transmission and/or feeder lines, voltage regulators, capacitor banks, reactors and/or the like.

Certain equipment associated with an electrical power generation and delivery system may be distributed in one or more sites and/or locations. For example, a variety of equipment (e.g., IEDs, network equipment, and/or the like) may be associated with a distribution substation location of an electric power delivery system. In some circumstances, distributed sites of an electrical power generation and delivery system may be located in relatively remote and/or infrequently accessed locations, and may be located at relatively large distances from an end user or load. For example, electric power may be generated initially at a large distance for an associated load at a relatively low voltage, and may be transformed into a relatively high voltage before entering a transmission system. The voltage may be reduced before entering a distribution system, and may also be reduced yet again before ultimate delivery to an end user or load. Various equipment included in an electric power generation and delivery system may be monitored, controlled, automated, and/or protected using intelligent electronic devices (“IEDs”) that receive electric power system information from the equipment, make decisions based on the information, and provide monitoring, control, protection, and/or automation outputs to the equipment.

In some embodiments, an IED may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communication processors, computing platforms, programmable logic controllers (“PLCs”), programmable automation controllers, input and output modules, governors, exciters, statcom controllers, access control systems, SVC controllers, OLTC controllers, and the like. Further, in some embodiments, IEDs may be communicatively connected via a network that includes, for example, multiplexers, routers, hubs, gateways, firewalls, and/or switches to facilitate communications on the networks, each of which may also function as an IED. Networking and communication devices may also be integrated into an IED and/or be in communication with an IED. As used herein, an IED may include a single discrete IED or a system of multiple IEDs operating together. IEDs may be interconnected using a variety of technologies and may utilize a variety of communication protocols and/or channels to facilitate communication therebetween.

In some embodiments, communication architectures facilitating communication of information between various IEDs may be configured for determinism. That is, the IEDs and various associated communication devices may be configured such that communications are transmitted to receiving devices before the expiration of the utility of a particular communication. For example, a control message communicating that a breaker should be closed at a particular time may be configured for transmission to a receiving device (e.g., a breaker controller) prior to the particular time so that the receiving device may effectively act on the control message.

In some circumstances, communications between IEDs may be multiplexed on the same physical medium. For example, communications between various IEDs may utilize a time-division multiplexed (“TDM”) protocol over a network that also allows for communication of packets according to the Ethernet protocol. In some embodiments, communication between various IEDs may be facilitated by one or more communication multiplexing devices such as the SEL ICON® device (available from Schweitzer Engineering Laboratories, Inc., of Pullman, Wash. USA) to allow for communication of TDM protocol and Ethernet communication on a single physical medium.

In certain embodiments, TDM protocol communications may be encapsulated in an Ethernet frame for communication on an Ethernet protocol network. For example, a multiplexing device may allow for transmission of encapsulated TDM protocol communications over the same physical medium as various Ethernet packets. As used herein, the term “TDM protocol communication” in certain instances may refer to a TDM protocol communication that has been encapsulated within an Ethernet frame for transmission on an Ethernet protocol network.

In some circumstances, when communication blocks attempt to enter a physical medium at the same time, a collision may occur. For example, an encapsulated TDM protocol communication and an Ethernet protocol packet attempting to enter a physical medium at the same time may collide. Lag in a TDM protocol communication resulting from a collision event, may undesirably cause the determinism of the TDM protocol communication to be lost. For example, the utility of time-sensitive information in an encapsulated TDM protocol communication may be lost if transmission of the communication is delayed. Embodiments disclosed herein may, among other things, preserve determinism of TDM communications over a physical medium that also carries Ethernet communications. By preserving determinism, various embodiments of the disclosed systems and methods may improve the transmission of data over communication channels in an electric power generation and delivery system.

Several aspects of the embodiments described herein are illustrated as software modules or components. As used herein, a software module or component may include any type of computer instruction or computer executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions. In some embodiments, the computer or other electronic device may include a processing device such as a microprocessor, microcontroller, logic circuitry, or the like. The processing device may further include one or more special purpose processing devices such as an application specific interface circuit (“ASIC”), programmable array logic (“PAL”), programmable logic device (“PLD”), field programmable gate array (“FPGA”), or any other customizable or programmable device.

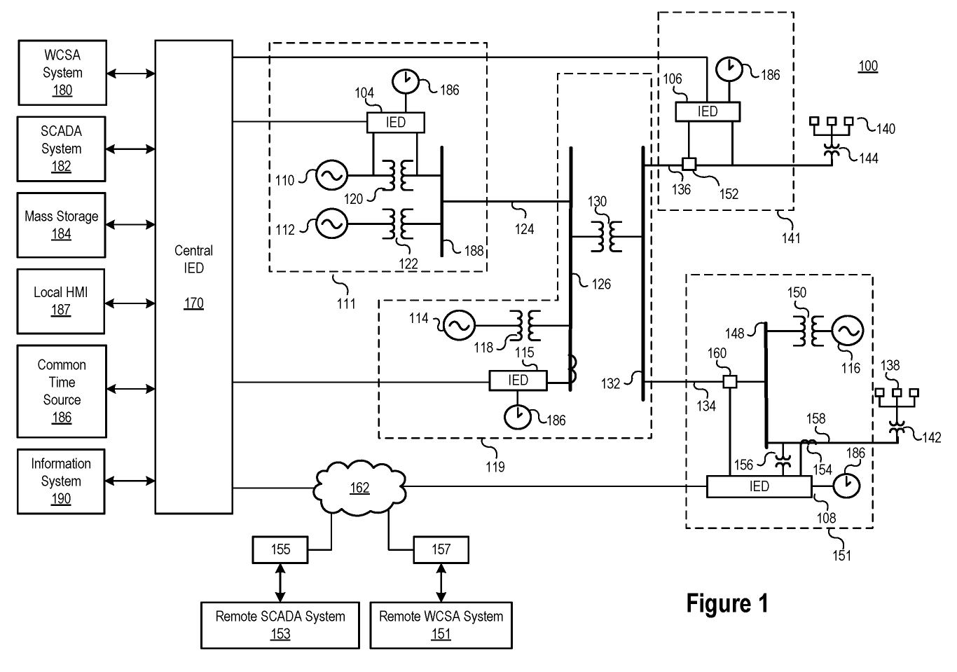

FIG. 1 illustrates a simplified one-line diagram of an electric power delivery system 100 and associated IEDs 104, 106, 108, 115 and 170 consistent with certain embodiments disclosed herein. System 100 includes various substations and IEDs 104, 106, 108, 115, and 170 configured to perform various functions. System 100 is provided for illustrative purposes and does not imply any specific arrangements or functions required of any particular IED. In some embodiments, IEDs 104, 106, 108, 115, and 170 may be configured to monitor and communicate information, such as voltages, currents, equipment status, temperature, frequency, pressure, density, infrared absorption, radio-frequency information, partial pressures, viscosity, speed, rotational velocity, mass, switch status, valve status, circuit breaker status, tap status, meter readings, and the like. Further, IEDs 104, 106, 108, 115, and 170 may be configured to communicate calculations, such as phasors (which may or may not comprise synchronized phasors such as synchrophasors), events, fault distances, differentials, impedances, reactances, frequency, and the like. IEDs 104, 106, 108, 115, and 170 may also communicate settings information, IED identification information, communications information, status information, alarm information, and the like. Information of the types listed above, or more generally, information about the status of monitored equipment, may be generally referred to herein as monitored system data.

In certain embodiments, IEDs 104, 106, 108, 115, and 170 may issue control instructions to the monitored equipment in order to control various aspects relating to the monitored equipment. For example, an IED (e.g., IED 106) may be in communication with a circuit breaker (e.g., breaker 152), and may be capable of sending an instruction to open and/or close the circuit breaker, thus connecting or disconnecting a portion of system 100. In another example, an IED may be in communication with a recloser and be capable of controlling reclosing operations. In another example, an IED may be in communication with a voltage regulator and be capable of instructing the voltage regulator to tap up and/or down. Information of the types listed above, or more generally, information or instructions directing an IED or other device to perform a certain action, may be referred to as control instructions.

The electric power delivery system 100 illustrated in FIG. 1 may include a generation substation 111. Generation substation 111 may include generators 110 and 112, which are connected to a bus 188 through step-up transformers 120 and 122. Bus 188 may be connected to bus 126 in substation 119 via transmission line 124. Although the equipment in substation 111 may be monitored and/or controlled by various IEDs, only a single IED 104 is shown. IED 104 may be a transformer protection IED for transformer 120. IED 104 may receive a common time signal 186 which, as indicated below, may be distributed in system 100 using a communications network or using a universal time source, such as GPS, or the like. Utilizing a common or universal time source may ensure that IEDs have a synchronized time signal that can be used to generate time synchronized data, such as synchrophasors.

Substation 119 may include a generator 114, which may be a distributed generator, and which may be connected to bus 126 through step-up transformer 118. Bus 126 may be connected to a distribution bus 132 via a step-down transformer 130. Various distribution lines 136 and 134 may be connected to distribution bus 132. Distribution line 136 may lead to substation 141 where the line is monitored and/or controlled using IED 106, which may selectively open and close breaker 152. Load 140 may be fed from distribution line 136. Further step-down transformer 144 may be used to step down a voltage for consumption by load 140.

Distribution line 134 may lead to substation 151, and deliver electric power to bus 148. Bus 148 may also receive electric power from distributed generator 116 via transformer 150. Distribution line 158 may deliver electric power from bus 148 to load 138, and may include further step-down transformer 142. Circuit breaker 160 may be used to selectively connect bus 148 to distribution line 134. IED 108 may be used to monitor and/or control circuit breaker 160 as well as distribution line 158.

A central IED 170 may be in communication with various IEDs 104, 106, 108, and 115, using a data communications network. IEDs 104, 106, 108, and 115 may be remote from central IED 170. The remote IEDs 104, 106, 108, and 115 may communicate over various media such as a direct communication from IED 106, over a wide-area communications network 162, or using network radios. IEDs 104, 106, 108, 115, and 170 may be communicatively linked together using a data communications network, and may further be communicatively linked to a central monitoring system, such as a supervisory control and data acquisition (SCADA) system 182, an information system (IS) 190, and/or a wide area control and situational awareness (WCSA) system 180.

The data communications network among IEDs 104, 106, 108, 115, and 170 may utilize a variety of network technologies, and may comprise network devices such as modems, multiplexors, routers, firewalls, virtual private network servers, and the like, which are not shown in FIG. 1. The various systems IEDs 104, 106, 108, 115, and 170 may further communicate via one or more networks comprising any suitable number of networks and/or network connections. The network connections may comprise a variety of network communication devices and/or channels and may utilize any suitable communication protocols and/or standards facilitating communication between the connected devices and systems. The network connections may comprise the Internet, a local area network, a virtual private network, and/or any other communication network utilizing one or more electronic communication technologies and/or standards (e.g., Ethernet or the like).

In some embodiments, the network connections may comprise a wireless carrier system such as a personal communications system (“PCS”), and/or any other suitable communication system incorporating any suitable communication standards and/or protocols. In further embodiments, the network connections may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network connections may incorporate one or more satellite communication links. In yet further embodiments, the network connections may utilize IEEE's 802.11 standards (e.g., Wi-Fi®), Bluetooth®, ultra-wide band (“UWB”), Zigbee®, and/or any other suitable communication protocol(s).

According to some embodiments, central IED 170 may be embodied as an automation controller, a communications processor, and/or an information processor. In various embodiments, central IED may be embodied as the SEL-2020, SEL-2030, SEL-2032, SEL-3332, SEL-3378, or SEL-3530 available from Schweitzer Engineering Laboratories, Inc. of Pullman, Wash., and also as described in U.S. Pat. No. 5,680,324, U.S. Pat. No. 7,630,863, and U.S. Patent Application Publication No. 2009/0254655, the entireties of which are incorporated herein by reference. In certain embodiments, the central IED 170 and/or any other system illustrated in FIG. 1 may be further communicatively coupled with one or more remote systems or IEDs including, for example, a remote SCADA system 153 and/or a remote WCSA system 159 via one or more network devices 155, 157 and/or interfaces.

The various IEDs in system 100 may obtain electric power information from monitored equipment using potential transformers (“PTs”) for voltage measurements (e.g., potential transformer 156), current transformers (“CTs”) for current measurements (e.g., current transformer 154), and the like. The PTs and CTs may include any device capable of providing outputs that can be used by the IEDs to make potential and current measurements, and may include traditional PTs and CTs, optical PTs and CTs, Rogowski coils, hall-effect sensors, and the like.

Each IED may be configured to access a common time source 186. The common time source 186 may be distributed via a communications network (using, for example, IEEE-1588 protocol, NTP protocol, or the like), or obtained locally at each IED. The common time source 186 may be a universal time, such as that delivered using global positioning system (GPS) satellites, WWVB, WWV, or the like. A common time may be used to time-synchronize measurements of the electric power system and/or in the calculation of synchrophasors. Measurements may be paired with a time stamp or time tag indicating a time at which the measurement was made. Accordingly, phasors calculated by the IEDs may include a time stamp indicating a time at which the measurement was made.

Central IED 170 may also be in communication with a number of other devices or systems. Such devices or systems may include, for example, a WCSA system 180, SCADA system 182, or local Human-Machine Interface (HMI) 187. Local HMI 187 may be used to change settings, issue control instructions, retrieve an event report, retrieve data, and the like. In some embodiments, WCSA system 180 may receive and process the time-aligned data, and may coordinate time synchronized control actions at the highest level of the electrical power generation and delivery system 100. Mass storage device 184 may store data relating to system 100 from IEDs 104, 106, 108, 115, and 170.

Central IED 170 may further include a time input, which may receive a time signal from a common time source 186. Time source 186 may also be used by central IED 170 for time stamping information and data. Time synchronization may be helpful for data organization, real-time decision-making, as well as post-event analysis. Time synchronization may further be applied to network communications. Time source 186 may be any time source that is an acceptable form of time synchronization, including, but not limited to, a voltage controlled temperature compensated crystal oscillator, Rubidium and Cesium oscillators with or without digital phase locked loops, microelectromechanical systems (MEMS) technology, which transfers the resonant circuits from the electronic to the mechanical domains, or a global positioning system (GPS) receiver with time decoding. In the absence of a discrete time source 186, central IED 170 may serve as a common time source by distributing a time synchronization signal.

Data communications between IEDs 104, 106, 108, 115, and 170 may occur using a variety of communication protocols, including Ethernet, TDM protocols, and the like. Consistent with the disclosed embodiments, communications between IEDs 104, 106, 108, 115, and 170 may allow for both TDM and Ethernet communication on a single physical medium. Information system 190 may generally include hardware and software to enable network communication, network security, user administration, Internet and intranet administration, remote network access and the like. Information system 190 may generate information about the network to maintain and sustain a reliable, quality, and secure communications network by running real-time business logic on network security events, perform network diagnostics, optimize network performance, and the like.

It will be appreciated that a number of variations can be made to the architecture and relationships presented in connection with FIG. 1 within the scope of the inventive body of work. Thus it will be appreciated that the architecture and relationships illustrated in FIG. 1 are provided for purposes of illustration and explanation, and not limitation.

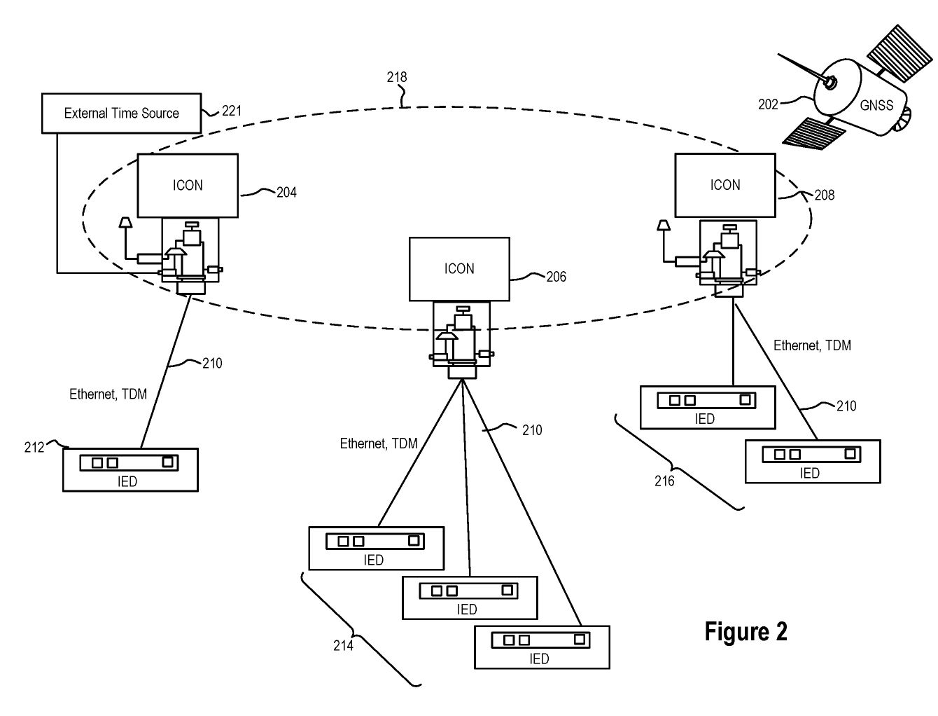

FIG. 2 illustrates a simplified block diagram of a communications system for communicating using multiple protocols on a communications network consistent with certain embodiments disclosed herein. In certain embodiments, the communications system may comprise a wide-area communications system configured to communicate using multiple protocols on a single physical communication medium. Embodiments of the illustrated communication system may be used in connection with facilitating communication between various IEDs, such as the IEDs illustrated in and described in connection with FIG. 1.

A network 218 may comprise various communications multiplexing devices 204, 206, 208, each in communication with IEDs 212, 214, 216 as illustrated. IEDs 212, 214, 216 may communicate with the related multiplexing devices 204, 206, 208 using various media and protocols 210 such as Ethernet, TDM protocols, and/or the like. The multiplexing devices 204, 206, 208 may be configured to facilitate communications between IEDs 212, 214, 216 via communications network 218 in a deterministic fashion for protocols that may require determinism such as certain TDM protocols. Thus, multiplexing devices 204, 206, 208 may receive various communications according to various protocols from the IEDs 212, 214, 216, and multiplex the various communications for transmission on the network 218. The multiplexing devices 204, 206, 208 may further be configured to distribute a common time signal from, for example, a GNSS signal 202, an external time source 221, or the like.

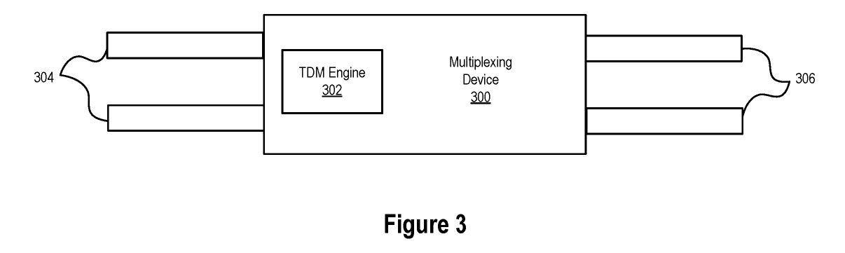

FIG. 3 illustrates a functional block diagram of a communication device 300 for communicating Ethernet and other communication packets on a network consistent with certain embodiments disclosed herein. In some embodiments, the communication device 300 may comprise a multiplexing device. For example, the communication device 300 may comprise an ICON device that includes a TDM engine 302 for processing an incoming TDM stream of communications 304 and an outgoing TDM stream of communications 306.

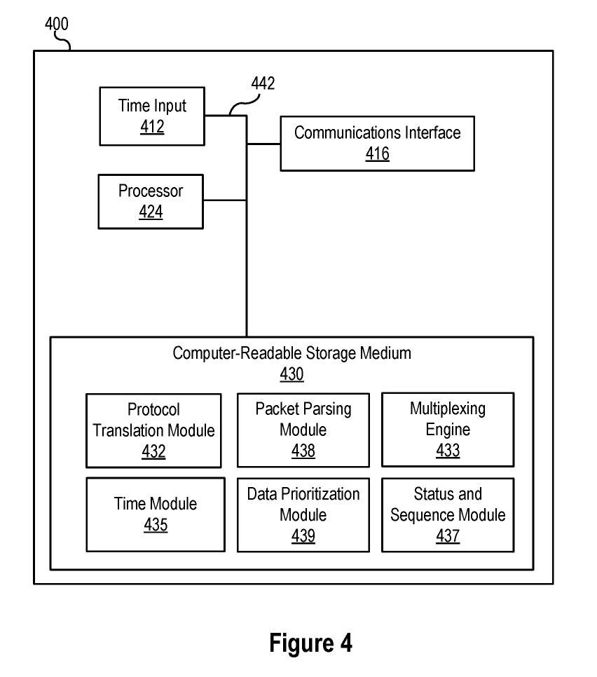

FIG. 4 illustrates a functional block diagram of a device 400 that may be used to improve the transmission of data over a communication channel consistent with certain embodiments disclosed herein. In some embodiments, the device 400 may comprise a communication multiplexing device that may be used in connection with improving data transmission. Although FIG. 4 illustrates a device 400 that may be capable of a variety of functions, according to further embodiments consistent with the present disclosure, devices having significantly less complexity and/or functionality may be utilized to implement systems and methods disclosed herein. For example, the functionality disclosed herein for improving transmission of data channel may be implemented by a network device, rather than a more complicated device such as an IED. Device 400 may be configured for bidirectional communication and, accordingly, may function as both a transmitting device and a receiving device.

The device 400 may include a communication interface 416. The communications interface 416 may facilitate communication with one or more networks (not shown). The network may be in communication with other IEDs and/or system devices, and may therefore allow device 400 to exchange information with such devices. In certain embodiments, the wired interface may facilitate direct communication with another similar device via a network (not shown). Device 400 may further include a time input 412, which may be used to receive a time signal (e.g., a common or universal time reference). In certain embodiments, a common time reference may be received via network communications interface 416, and accordingly, a distinct time input 412 may not be required for time-stamping and/or synchronization operations. At least one such embodiment may employ the IEEE 1588 protocol.

The processor 424 may be configured to process communications received via network communications interface 416, and/or time input 412. Processor 424 may operate using any number of processing rates and architectures. Processor 424 may be configured to perform various algorithms and calculations described herein. Processor 424 may be embodied as a general purpose integrated circuit, an ASIC, a FPGA, and/or any other suitable programmable logic device.

A non-transitory computer-readable storage medium 430 may be a repository of various software modules configured to perform any of the methods described herein and/or any aspects thereof. A data bus 442 may link a monitored equipment interface (not shown), time input 412, a network communications interface 416, and computer-readable storage medium 430 to processor 424.

A protocol translation module 432 may be configured to allow device 400 to communicate with any of a variety of external devices via network communications interface 416. The protocol translation module 432 may be configured to communicate using a variety of data communication protocols (e.g., TCP/IP, IEC 61850, TDM protocols, Ethernet, etc.). Further, the protocol translation module 432 may be configured to translate data from one communications protocol to another communications protocol in order to improve bandwidth utilization and/or decrease communication latency associated with certain higher priority data.

The protocol translation module 432 may further be configured to encapsulate TDM protocol communications into segments capable of transmission on a communications network operating according to the Ethernet protocol. Such encapsulated TDM protocol communications may then be transmitted on the communications interface along with the Ethernet communications. As discussed above, encapsulated TDM protocol communications may be referred to herein in certain instances generally as TDM protocol communications. The status and sequence module 437 (described in more detail below) may be configured to sequence the encapsulated TDM protocol communications and the Ethernet communications.

A packet parsing module 438 may be configured to parse messages in a stream of data packets and to identify higher priority data and lower priority data contained within each data packet. Higher priority data may be transmitted in a prioritized manner in order to reduce the latency associated with such data. According to various transmission protocols, a data packet may comprise several types of data. These parts of the message may have different character, purpose and user application. In order to limit the bandwidth requirements and minimize transmission latency, these parts may be identified and treated appropriately. A data prioritization module 439 may operate in conjunction with packet parsing module 438 to prioritize the transmission of higher priority data. Consistent with embodiments herein, packet parsing module 438 may further be configured to parse communications in one or more incoming communication streams based on a type of data and/or a type of associated communication protocol (e.g., parse encapsulated TDM communications and Ethernet communications).

A time module 435 may be configured to encode time information (e.g., a timestamp associated with a message) as in a relatively efficient manner. In some embodiments, the time module 435 may rely on an assumption that time will drift slowly between a transmitting device and a receiving device. This assumption may especially be true in embodiments where each transmitting device and each receiving device receives a common time signal (e.g., a time signal from the GPS system). According to some embodiments, the time information may be transmitted according to a fixed schedule or availability of capacity in the low-bandwidth communication channel in order to limit drift between a transmitting device and a receiving device. In further embodiments, a relatively short data value may represent an increment of time elapsed from a previously transmitted time value.

A status and sequence module 437 may be configured to generate or increment at a receiving device status and sequence numbers associated with a message stream. As further described herein, the status and sequence module 437 may be configured to preserve determinism of a TDM protocol communication while maintaining transmission of communications on other protocols such as, for example, an Ethernet protocol. Consistent with embodiments disclosed herein, determinism may be preserved by monitoring the timing of communications on an outbound communications port for possible collision. When an Ethernet communication is determined to likely collide with a TDM protocol encapsulated communication, the status and sequence module 437 may delay transmission of the Ethernet communication until after the completion of transmission of the particular TDM protocol communication. In some embodiments, various functionality and/or modules may be incorporated into a multiplexing engine 433 (e.g., a TDM engine) configured to, among other things, preserve determinism of a TDM protocol communication consistent with embodiments disclosed herein.

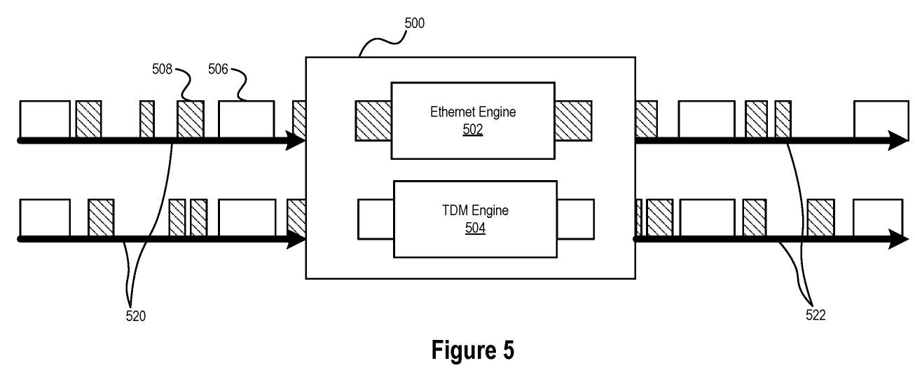

FIG. 5 illustrates a functional block diagram of a communication device 500 consistent with certain embodiments disclosed herein. In some embodiments, the communication device 500 may comprise a multiplexing device. The device 500 may be in communication with incoming messages on two inbound message streams 520 that include both Ethernet communications 506 and TDM protocol communications 506 (e.g., encapsulated TDM protocol communications). The multiplexing device 500 may comprise an Ethernet engine 502 for processing incoming Ethernet communications 506 and directing them to a proper outbound port providing an outbound message stream 522. The multiplexing device 500 further comprises a TDM engine 504 for processing incoming TDM protocol communications 506 and directing them to a proper output port providing an outbound message stream 522. Consistent with embodiments disclosed herein, the TDM engine 504 may further be configured to preserve determinism of TDM protocol communications by reducing possible collisions on the outbound ports.

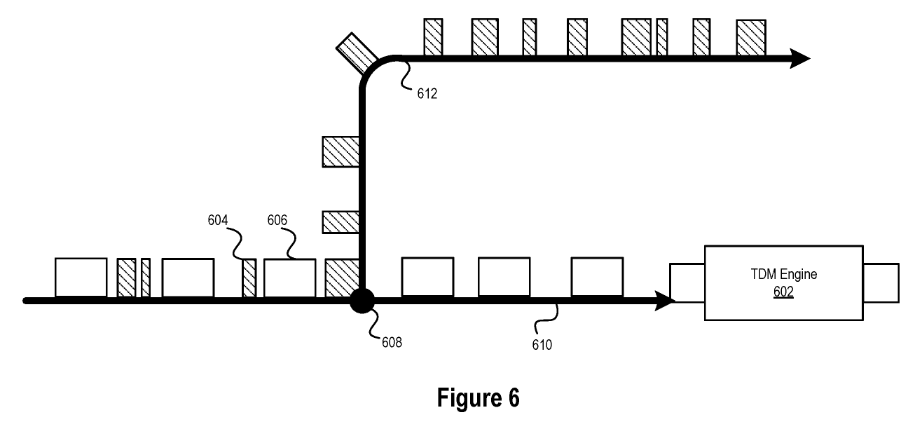

FIG. 6 illustrates a conceptual diagram of inbound communications traffic of a communication device, which may comprise a multiplexing device, consistent with certain embodiments disclosed herein. As shown, encapsulated TDM protocol communications 606 and Ethernet communications 604 may be received via a single communications port and/or via a single communications medium. At 608, the communications 604, 606 may be separated based on their respective protocols into an Ethernet stream 612 and a TDM stream 610. In some embodiments, The TDM stream 610 may be provided to a TDM engine 602 for further processing.

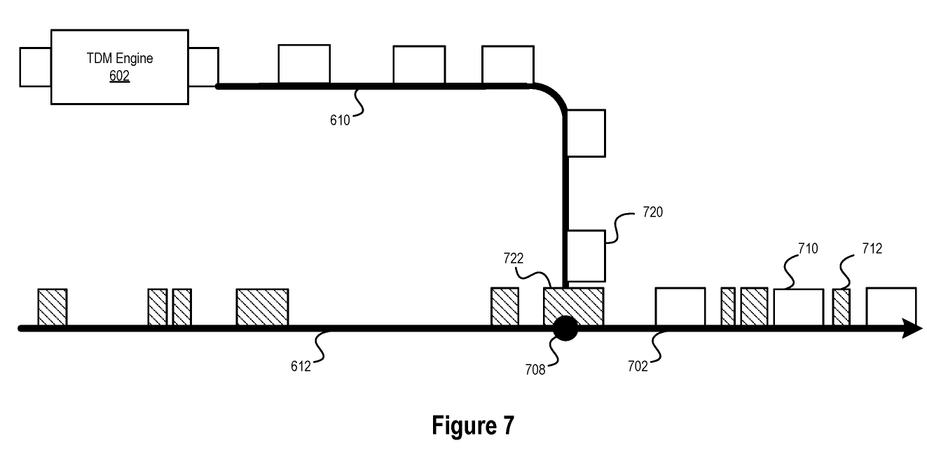

FIG. 7 illustrates a conceptual diagram of outbound communication traffic of a communication device, which may comprise a multiplexing device, consistent with certain embodiments disclosed herein. As shown, Ethernet communications 712 from an Ethernet stream 612 may be combined with encapsulated TDM protocol communications 710 from a TDM stream 610 for transmission on a same physical medium 702 at outbound port 708. As illustrated, in some circumstances, an encapsulated TDM protocol communication 720 may collide with an Ethernet communication 722. Such a collision may cause delay of transmission of the encapsulated TDM protocol communication 720, which may detrimentally impact the determinism of the encapsulated TDM protocol communication. As detailed below, consistent with embodiments disclosed herein, the TDM engine 602 may be configured to engage in actions which preserve determinism of encapsulated TDM protocol communications 710 by prioritizing transmission of encapsulated TDM protocol communications 710 and reducing possible collisions on the outbound port 708.

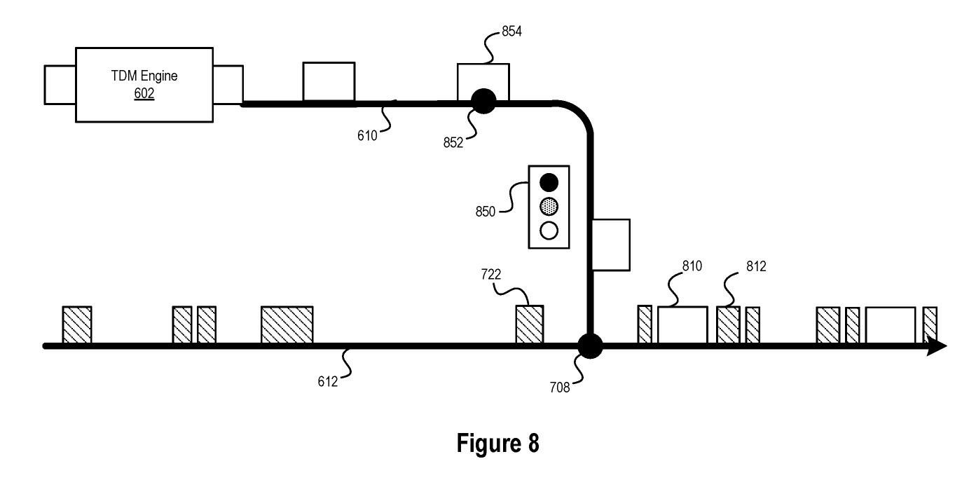

FIG. 8 illustrates another conceptual diagram of outbound communication traffic of a communication device, which may comprise a multiplexing device, consistent with certain embodiments disclosed herein. In some embodiments, the communication device may be configured to engage in actions which preserve determinism of encapsulated TDM protocol communications 810 by reducing possible collisions on the outbound port 708. In some embodiments, methods for preserving the determinism of encapsulated TDM protocol communications may be implemented by the TDM engine 602 and/or a delay module 850 separate from and/or associated with the TDM engine 602.

Consistent with embodiments disclosed herein, the TDM engine 602 and/or the delay module 850 may examine encapsulated TDM protocol communications along the TDM stream 610 and Ethernet communications along the Ethernet stream 612 to identify possible collisions at the outbound port 708. For example, approaching encapsulated TDM protocol communications (e.g., TDM protocol communication 854) may be detected at a point 852 along the TDM stream 610 and analyzed to determine if they will and/or are likely to collide with Ethernet communication at the outbound port 708. In some embodiments, an approaching encapsulated TDM protocol communication 854 may be analyzed to determine if it is scheduled to egress through the outbound port 708 at the same time and/or within a period of time as an Ethernet packet. If the encapsulated TDM protocol communication 854 will egress the outbound port 708 at the same time and/or within the same time period as the Ethernet packet, a possible collision may be identified.

If a possible collision at the outbound port 708 is identified, the TDM engine 602 and/or the delay module 850 may delay the transmission of the colliding Ethernet packet in favor of the encapsulated TDM protocol communication (e.g., TDM protocol communication 854). The encapsulated TDM protocol communication may be allowed to be transmitted via the outbound port 708 prior to transmission of the Ethernet packet. In some embodiments, the colliding Ethernet packet may be stored in a buffer associated with the TDM engine 602 and/or the delay module 850 until it is determined that the encapsulated TDM protocol communication has successfully egressed and/or otherwise cleared the outbound port 708. In this manner, the device may provide a stream of outbound encapsulated TDM protocol communications 810 and Ethernet packets 812 via a single port 708 and/or a single physical medium while reducing outbound port collisions and/or otherwise preserving the determinism of the encapsulated TDM protocol communications 810.

Possible collision between various communications at an outbound port 708 of a device may be detected in a variety of ways. For example, in some embodiments, a frame length of an encapsulated TDM protocol communication 854 and/or a possible colliding Ethernet packet may be analyzed in connection with known and/or determined device processing and/or transmission speeds to determine when each of the packets are scheduled to egress the outbound port 708. Possible collisions may be identified based on the determined times. In further embodiments, possible collisions may be identified upon ingress of the communications into a communications device such as an Ethernet switch. For example, in some embodiments, upon ingress into a communications device, an EtherType in an Ethernet frame of a communication may be analyzed to determine whether the communication is an encapsulated TDM protocol communications or an Ethernet communication. A time to process the frame through the communication device may be determined (e.g., based on the frame length and/or processing/transmission speeds) to identify when the communication is scheduled to egress the outbound port. If the communication comprises an encapsulated TDM protocol communication, the communication device may preemptively clear an output buffer and/or queue when the communication is scheduled to egress the outbound port to ensure that the outbound port is clear when the communication is to be transmitted from the device (e.g., by delaying and/or otherwise buffering a colliding Ethernet communication or the like).

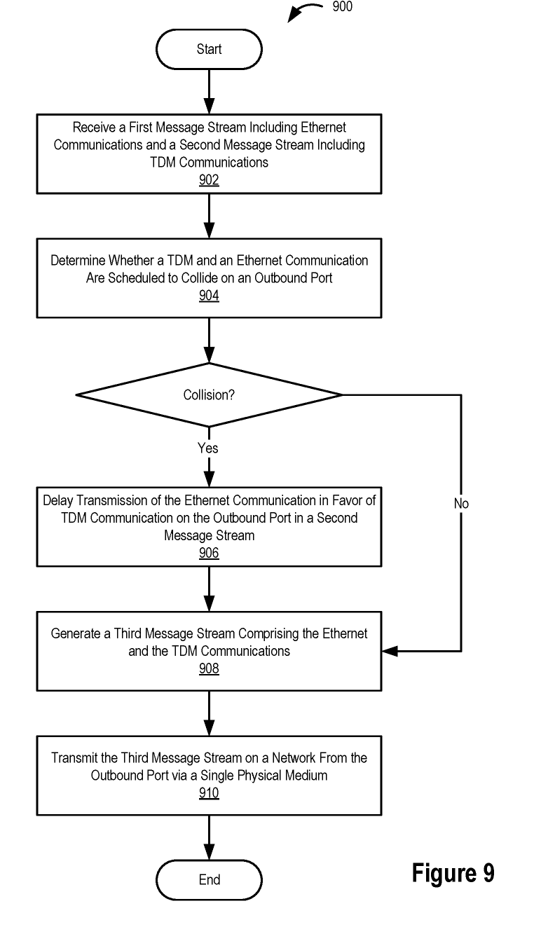

FIG. 9 illustrates a flow chart of a method for managing communication traffic consistent with certain embodiments disclosed herein. In certain embodiments, elements of the method 900 may be performed by an IED, a network device, a TDM engine, a delay module, and/or any other suitable system, engine, or module or combination thereof.

At 902, a first message stream may be received that includes Ethernet communications (e.g., Ethernet packets) and a second message stream may be received that includes TDM protocol communications (e.g., encapsulated TDM protocol communications). A determination may be made at 904 regarding whether a TDM communication and an Ethernet communication are scheduled to collide on an outbound port of the device. For example, the relative timing of the TDM communication and the Ethernet communication in their respective streams may be examined to determine a time when they will arrive at an outbound port of the device. If the communications are scheduled to arrive at the same time and/or within a certain period of time, it may be determined at 904 that the communications are scheduled to collide. If the communications are not scheduled to arrive at the outbound port at the same time and/or within the certain period of time, it may be determined at 904 that the communications are not scheduled to collide.

If the TDM communication and the Ethernet communication are scheduled to collide on the outbound port, the method 900 may proceed to 906, where the TDM protocol communication may be allowed to be transmitted via the outbound port as part of a second message stream (e.g., a message stream comprising both TDM protocol and Ethernet communications on a single physical medium) prior to transmission of the Ethernet packet. In certain embodiments, the TDM protocol communication may be prioritized by delaying transmission of the Ethernet communication in favor of the TDM protocol communication. For example, the Ethernet communication may be delayed until it is determined that the TDM protocol communication has cleared the outbound port. In some embodiments, the colliding Ethernet communication may be stored in a buffer prior to transmission.

At 908, a third message stream may be generated that includes both Ethernet and TDM protocol communications, with any colliding Ethernet communications delayed to prioritize the transmission of TDM protocol communications. If at 904 it is determined that there are no collisions between TDM protocol communication and Ethernet communications, the method 900 may proceed to 908 and generate the third message stream without delaying any Ethernet communications to avoid possible collisions. The third message stream comprising both TDM protocol communications and Ethernet communications may be transmitted from the outbound port at 910 via a single physical medium. In this manner, a device implementing method 900 may provide a stream of outbound TDM protocol communications and Ethernet packets via a single port and/or a single physical medium while reducing delay transmission and/or outbound port collisions and/or otherwise preserving the determinism of the TDM protocol communications.

While specific embodiments and applications of the disclosure have been illustrated and described, it is to be understood that the disclosure is not limited to the precise configurations and components disclosed herein. For example, the systems and methods described herein may be applied to a variety of IED and/or network devices in an electric power generation and delivery system in a variety of suitable configurations. It will further be appreciated that embodiments of the disclosed systems and methods may be utilized in connection with a variety of systems, devices, and/or applications, and/or applications that are not associated with and/or are otherwise included in an electric power delivery system. Accordingly, many changes may be made to the details of the above-described embodiments without departing from the underlying principles of this disclosure. The scope of the present invention should, therefore, be determined only by the following claims.

What is claimed is:

1. A system for communicating deterministic communications comprising:
a communications interface configured to receive a first communication formatted according to a first communication protocol and a second communication formatted according to a second communication protocol, the first communication comprising a deterministic communication;
a packet parsing module in communication with the communications interface configured to parse the first communication into a first stream and the second communication into a second stream;
a multiplexing engine configured to:
determine a first scheduled egress time of the first communication from an outbound port of the system;
determine a second scheduled egress time of the second communication from the outbound port;
determine that the first communication and the second communication are scheduled to collide at the outbound port based on the first scheduled egress time and the second scheduled egress time; and
delay transmission of the second communication until the first communication has egressed the outbound port.

2. The system of claim 1, wherein the first communication protocol comprises a time-division multiplexed communication protocol.

3. The system of claim 2, wherein the first communication comprises a time-division multiplexed communication protocol encapsulated in an Ethernet frame.

4. The system of claim 1, wherein the second communication protocol comprises an Ethernet protocol.

5. The system of claim 1, wherein the packet parsing module is configured to parse the first communication based, at least in part, on an EtherType field included in a frame associated with the first communication.

6. The system of claim 1, wherein the packet parsing module is configured to parse the second communication based, at least in part, on an EtherType field included in a frame associated with the second communication.

7. The system of claim 1, where the multiplexing engine is configured to delay transmission of the second communication by buffering the second communication until the first communication has egressed the outbound port.

8. The system of claim 1, wherein determining that the first communication and the second communication are scheduled to collide at the outbound port comprises determining that the first scheduled egress time and the second scheduled egress time occur at a same time.

9. The system of claim 1, wherein determining that the first communication and the second communication are scheduled to collide at the outbound port comprises determining that the first scheduled egress time and the second scheduled egress time occur within a predefined period of time.

10. The system of claim 1, wherein determining the first scheduled egress time is based, at least in part, on a first frame length associated with the first communication and determining the second scheduled egress time is based, at least in part, on a second frame length associated with the second communication.

11. The system of claim 1, wherein determining the first scheduled egress time and the second scheduled egress time is based, at least in part, on a communication processing speed of the system.

13. A method performed by a system for communicating deterministic communications, the method comprising:
receiving a first communication formatted according to a first communication protocol;
receiving a second communication formatted according to a second communication protocol;
parsing the first communication into a first stream and the second communication into a second stream;
determining a first scheduled egress time of the first communication from an outbound port of the system;
determining a second scheduled egress time of the second communication from the outbound port of the system;
identifying a scheduled collision event at the outbound port based on the first scheduled egress time and the second scheduled egress time; and
delaying transmission of the second communication until the first communication has egressed the outbound port.

14. The method of claim 13, where the first communication protocol comprises a time-division multiplexed communication protocol.

15. The method of claim 14, wherein the second communication protocol comprises a time-division multiplexed communication protocol encapsulated in an Ethernet frame.

16. The method of claim 13, wherein the second communication protocol comprises an Ethernet protocol.

17. The method of claim 13, where the first communication is configured to be parsed based, at least in part, on an EtherType field included in a frame associated with the first communication.

18. The method of claim 13, wherein the packet parsing module is configured to parse the second communication based, at least in part, on an EtherType field included in a frame associated with the second communication.

19. The method of claim 13, wherein delaying transmission of the second communication comprises buffering the second communication until the first communication has egressed the outbound port.

20. The method of claim 13, wherein identifying a scheduled collision event at the outbound port comprises determining that the first scheduled egress time and the second scheduled egress time occur at a same time.

21. The method of claim 13, wherein identifying a scheduled collision event at the outbound port comprises determining that the first schedule scheduled egress time and the second scheduled egress time occur within a predefined period of time.

22. The method of claim 13, wherein determining the first scheduled egress time is based, at least in part, on a first frame length associated with the first communication and determining the second scheduled egress time is based, at least in part, on a second frame length associated with the second communication.

23. The method of claim 13, wherein determining the first scheduled egress time and the second scheduled egress time is based, at least in part, on a communication processing speed of the system.
